(19) United States
(12) Patent Application Publication
(10) Pub. No.: US 2021/0262514 A1
(43) Pub. Date: Aug. 26, 2021

(54) PILOTED SELF-LOCATING NUT WITH WELD FLANGE

(71) Applicant: AGCO Corporation, Duluth, GA (US)

(72) Inventor: Steven Douglas MAY, Hesston, KS (US)

(21) Appl. No.: 16/801,720

(22) Filed: Feb. 26, 2020

(51) Int. Cl. F16B 37/12

(52) U.S. Cl. CPC F16B 37/12

(57) ABSTRACT

A weld nut for use with a bolt connector configured to extend through preformed holes in two or more plate components that are to be jointed together. The weld nut has a nut body with a threaded central bore passing through the nut body. A weld flange projects outwardly from a central axis of the weld nut, the weld flange forming a surface area radially outwardly of and surrounding the nut body. A circular pilot extends from the weld flange along the central axis around the central bore. The plate components each have a joining hole formed therein. The bolt connector has a threaded shaft portion having an external surface thread. The weld nut is centered over the joining hole in the second plate component with the pilot inserted into the joining hole. The threaded shaft portion engages the threaded central bore to join the plate components.

### BACKGROUND OF THE INVENTION

### Field of Invention

This invention relates generally to weld nuts, and more particularly to a piloted self-locating nut having a weld flange.

### Description of Related Art

Centering a hex nut over a bolt-receiving hole in a component and then welding the hex nut in place is a common practice. Some hex nuts have weld projections, such as small dimples that concentrate heat in controlled areas, on a component-facing side of the nut. When the nut is welded to another component, it is necessary to properly orient the nut so that the projections face the component to which the nut is to be welded. This need to correctly orient the nut can cause manufacturing and welding problems. First the nut must be placed on the component over a pin that centers it on the hole. This can be done manually or mechanically. If done manually, the nut may be incorrectly oriented due to human error. If the nut is located mechanically, there is an increased cost for the tooling required to orient and locate the nut. And even when done mechanically, errors still can result. For example, if the nut is applied upside down, the nut will either not weld to the component, resulting in immediate failure of the weld, or the weld will be weak and fail in shipping or in use or when a threaded fastener is screwed into the nut.

There is an additional problem in that the welding step can cause thread distortion or weld spatter in the threads, resulting in the necessity to chase the threads with a tap before assembly. Additionally, the component material surface must be clean and free of rust, scale, oil, etc., in order to achieve proper bonding of the nut to the surface. Often, the steel sheet and plate material to which the nut is to be welded is not clean enough to assure proper bonding. These problems cause failures that lead to high repair, scrap, and inspection costs.

### OVERVIEW OF THE INVENTION

In one embodiment, the invention is directed to a weld nut for use with a bolt connector configured to extend through preformed holes in two or more plate components that are to be jointed together. The weld nut has a nut body with a threaded central bore passing through the nut body. A weld flange projects outwardly from a central axis of the weld nut, the weld flange forming a surface area radially outwardly of and surrounding the nut body. A circular pilot extending from the weld flange along the central axis around the central bore.

The weld nut is used with an assembly including the bolt connector and the first and second plate components. The first and second plate components each have a joining hole formed therein. The bolt connector has a head portion and a threaded shaft portion having an external surface thread, wherein the head portion has an outer diameter slightly larger than the diameter of the joining holes in the first and second plate components. The weld nut is centered over the joining hole in the second plate component with the pilot inserted into the joining hole in the second plate component. The threaded shaft portion is configured to engage the threaded central bore in the weld nut to join the first and second plate components.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is an exploded perspective view of two plate components that are to be jointed together with a bolt connector and weld nut in accordance with the principles of the present invention; and

FIG. 2 is side view of two plate components, bolt connector and weld nut of FIG. 1.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

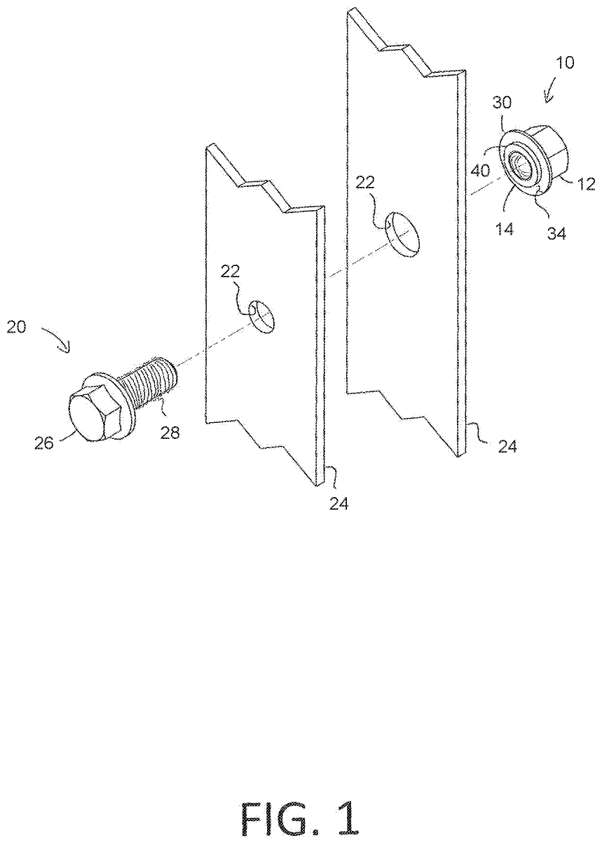

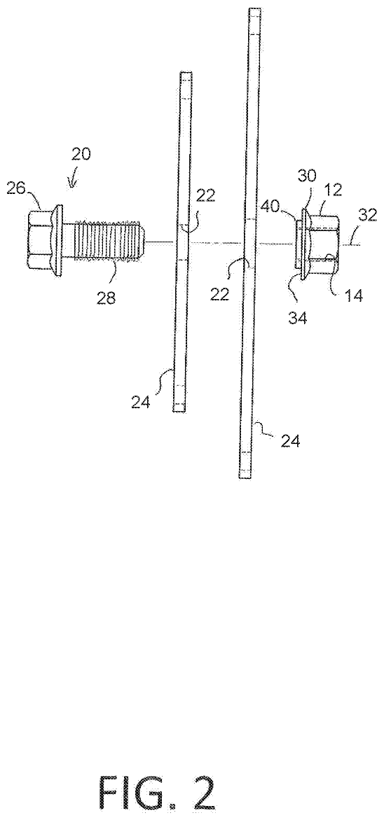

Referring now more particularly to FIGS. 1 and 2, there is shown a weld nut 10 having a nut body 12 provided with a threaded central bore 14 passing through the nut body 10. The weld nut 10 is used with a corresponding bolt connector 20 that extends through preformed holes 22 in two or more plate components 24 that are to be jointed together. The nut body 12 may have a hexagonal shape as is common with a conventional nut. The bolt connector 20 includes a head portion 26 and a threaded shaft portion 28 having an external surface thread. The head portion 26 has an outer diameter slightly larger than the diameter of the holes 22 in the plate components 24. The head portion 26 may comprise a hex shape, as shown, or may take on a rounded or other shape. Drive for the head portion 26 may be provided through the external hex shape, or through the use of other means such as a slot, cross, Allen-type, star-type, etc. The threaded shaft portion 28 has an outer diameter slightly smaller than the diameter of the holes 22.

The weld nut 10 has a weld flange 30 projecting outwardly from a central axis 32 of the weld nut 10. The weld flange 30 forms a surface area radially outwardly of and surrounding the nut body 12. The weld flange 30 desirably has a mating surface 34 that is generally flat and intended engage the surface of the adjacent plate 24. The hex nut 10 also has a circular pilot 40 extending from the weld flange 30 along the central axis 32 around the central bore 14. The pilot 40 has an outer diameter slightly smaller than the diameter of the holes 22 in the plate components 24.

In assembling the plate components 24, the weld nut 10 is centered over the hole 22 in the adjacent plate component 24 with the pilot 40 being inserted into so as to be resting within the hole 22. With the weld nut 10 properly held in position by the pilot 40, the weld flange 30 is welded to the surface of the adjacent plate component 24. The shaft portion 28 of the bolt connector 20 is configured to pass through the holes 22 in the plate components 24, with the head portion 26 resting against its adjacent plate component 24. The threaded shaft portion 28 of the bolt connector 20 mates with the central threaded bore 16 of the weld nut 10. Tightening of the bolt connector 20 secures the one plate component 24 to the other plate component 24. The weld flange 30 on the weld nut 10 permits tack welding on the perimeter of the weld flange 30 in an area away from the nut body 12 and central bore 14 so as to minimize the chance of thread distortion or weld splatter spoiling the threaded central bore 14 that would typically require the assembler to have to chase the threaded bore with a tap after welding and before assembly.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A weld nut for use with a bolt connector configured to extend through preformed holes in two or more plate components that are to be jointed together, the weld nut comprising:
a nut body having a threaded central bore passing through the nut body;
a weld flange projecting outwardly from a central axis of the weld nut, the weld flange forming a surface area radially outwardly of and surrounding the nut body; and
a circular pilot extending from the weld flange along the central axis around the central bore.

2. The weld nut of claim 1 wherein the nut body has a hexagonal shape.

3. The weld nut of claim 1 wherein the weld flange has a flat mating surface configured to engage a surface of an adjacent plate component.

4. An assembly including the weld nut of claim 1, the assembly also comprising a bolt connector and first and second plate components, the first and second plate components each having a joining hole formed therein, wherein the bolt connector has a head portion and a threaded shaft portion having an external surface thread, wherein the head portion has an outer diameter slightly larger than the diameter of the joining holes in the first and second plate components, wherein the weld nut is centered over the joining hole in the second plate component with the pilot inserted into the joining hole in the second plate component, and the threaded shaft portion is configured to engage the threaded central bore in the weld nut to join the first and second plate components.
